(19) United States
(12) Patent Application Publication
(10) Pub. No.: US 2009/0030222 A1
(43) Pub. Date: Jan. 29, 2009

(54) SYSTEMS AND METHODS FOR FUNCTIONALIZING PARTICULATES WITH SILANE-CONTAINING MATERIALS

(75) Inventors: Gary Lee Gibson, Midland, MI (US); Keith Quentin Hayes, Florence, KY (US); Csilla Kollar, Midland, MI (US); Anthong Revis, Freeland, MI (US); Raymond Lee Tabler, Midland, MI (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Dow Corning Corporation

(21) Appl. No.: 12/160,476

(22) PCT Filed: Dec. 28, 2006
(86) PCT No.: PCT/US2006/049377

§ 371 Date: Jul. 10, 2008

Related U.S. Application Data
(60) Provisional application No. 60/760,065, filed on Jan. 19, 2006.

(51) Int. Cl. C07F 7/08; B01J 8/08

(52) U.S. Cl. 556/478; 422/215

(57) ABSTRACT

Systems and methods of functionalizing particulates are provided. A method of functionalizing particulates includes providing particulates to a reactor, fluidizing the particulates in substantial absence of solvents, providing a silane containing material to the fluidized particulates, and reacting the silane containing material with the fluidized particulates to provide silane-functionalized particulates. The silane-functionalized particulates may be utilized in separation media and other industrial applications.

The present invention is directed to methods and systems for functionalizing particulates, and more specifically to a method of producing silane-functionalized particulates to be used in separation media.

The functionalizing of silica is an established process. Most silicas are treated in a “wet” process. The “wet” process is a silane functionalization process, which utilizes a solvent to effectively slurry an entire load of particulates. The majority of the weight of a processed mass, which includes particulates, additives, and solvent, is composed of solvent. A high solvent concentration is designed to promote the intimate contact of the reactive additive i.e. silane and the surface of the particulates with the goal of initiating a reaction between the additive and some reactive site on the surface. Generally, the wet process requires a relatively long batch time, typically ranging from 1-24 hours at higher than ambient temperature, to complete the reaction.

Moreover, the high solvent concentration necessitates multiple additional washing steps. Once the reactive additive has attached to the surface, the solvent and by-product of the reaction must be removed to return the particulate to a usable dry state. At least one and usually multiple solvent washing steps are required to remove unreacted silane. However, each additional washing step increases the volume of waste solvent from the process, creating disposal problems. As the capacity of the process increases, disposal costs for the solvent will increase as well.

Alternatively, a “dry” process may be used to functionalize silica. In the dry process, the silane additive is provided to a mixture that is mostly composed of materials with which it will react, as opposed to the “wet” process where most of the processed mass is a solvent that is inert to reaction with the specific additive. The dry process utilizes a high viscosity polymer, such as a rubber, to compound the particulate. In this instance, the additive is intended to make a particulate (such as a powder) and a polymer more compatible. This promotes better mixing of the polymer and the particulate for the purposes of volume extension or rheological modification, etc. In the dry process, the silane and particulates are simply compounded in a mixture, and are not strongly attached or bound to one another. The silane is basically used as a simple additive that is sprayed into the pre-blend of polymer and particulate to make the particulate more compatible with the polymer.

As advances in separation processes are made, the need arises for improvements in methods of producing components used in separation media, including improved methods of producing silane-functionalized particulates.

According to one embodiment of the present invention, a method of functionalizing particulates is provided. The method comprises the steps of providing particulates to a reactor, fluidizing particulates in the substantial absence of solvents, providing a silane containing material to the fluidized particulates, and reacting the silane containing material with the fluidized particulates to provide silane functionalized particulates.

According to another embodiment of the present invention, a system for functionalizing particulates is provided. The system comprises a reactor operable to create and maintain a fluidized bed of particulates, a source of a silane containing material, and a spraying mechanism operable to spray the silane containing material onto the fluidized bed of particulates.

Embodiments of the systems and methods for functionalizing particulates with a silane-containing material of the present invention are advantageous, especially in applications utilizing separation media. These and additional features and advantages provided by the systems and methods will be more fully understood in view of the following detailed description and accompanying drawings.

The following detailed description of specific embodiments of the present invention can be best understood when read in conjunction with the drawings enclosed herewith. The drawing sheets include:

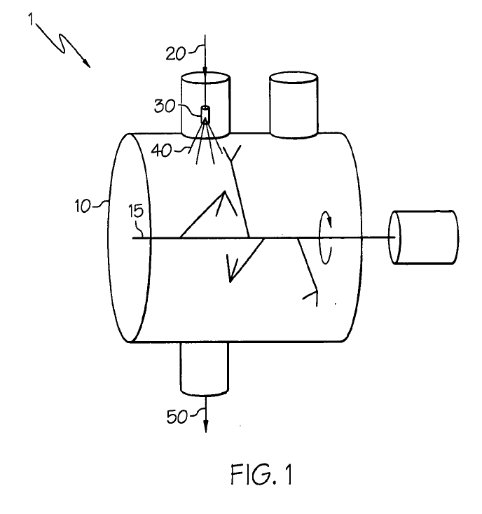

FIG. 1 is a schematic view of a fluidized bed apparatus according to one or more embodiments of the present invention.

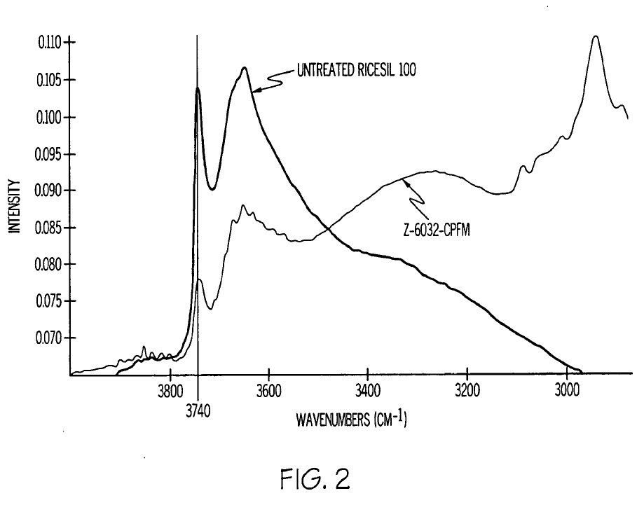

FIG. 2 is a graphical illustration demonstrating the chemical attachment of the silane-containing material to the particulates according to one or more embodiments of the present invention.

According to one embodiment of the present invention, a method of functionalizing particulates is provided. The method comprises the steps of: providing particulates to a reactor, fluidizing particulates in the substantial absence of solvents, providing a silane containing material to the fluidized particulates; and reacting the silane containing material with the fluidized particulates to provide silane functionalized particulates.

The particulates may comprise numerous materials known to one skilled in the art. The particulates may comprise amorphous silica, wherein the amorphous silica is typically of biogenic origin. Specifically, the amorphous silica may comprise rice hull ash, oat bran ash, wheat chaff ash, or combinations thereof. In alternative embodiments, the particulates may also comprise inorganic materials. The inorganic materials may comprise diatomaceous earths, high-pressure liquid chromatography (HPLC) grade silica, titania, zirconia, and combinations thereof. Other examples of particulates may include talc, calcium carbonate, silica xerogels, silica hydrogels, fumed silica, silica fume, natural clays, diatomaceous earth, and other particulate materials known to one skilled in the art. The size of the particulates may vary; however, the particulates typically comprise a particle size of up to about 500 μm, or up to about 250 μm, or about 110 μm to about 200 μm, or about 5 μm to about 75 μm, or about 25 to about 50 μm. The particulates may also comprise mixtures of any of the above described particulate materials.

Any suitable feeding means known to one skilled in the art may be utilized in providing the particulates to the reactor. The particulates may be fed manually, for example, by simply pouring from a container. The particulates may also be fed by a gravitational loading device typically oriented above the reactor. Conveying devices, for example, pneumatic conveying, vibratory conveying, auger or screw conveying, and belt conveying devices, may also be used as feeding devices. Additional feeding devices may include an enclosed or open chute, a bucket elevator, “plates on a rope”, or the like.

The reactor may comprise any apparatus suitable to fluidize particulates fed to the reactor and maintain the particulates at desired conditions. In one embodiment, the reactor may comprise a plow blade mixer 10 as shown in FIG. 1. The plow blade mixer is operable to fluidize the particulates while minimizing particle attrition. Referring to FIG. 1, a plow blade mixer 10 works by mechanically fluidizing a load of particulates by stirring it with an agitator 15 in such a way that it becomes a flowing mass of air, other gases, and particles. Fluidization may also be accomplished pneumatically by blowing air or other gases through a bed of particles to achieve a flowing mass; however mechanical fluidization is preferred. Other possible fluidization devices include a Nauta® mixer (orbiting auger in a cone), a ribbon mixer (horizontal helical blade) a Forberg® mixer (twin fluidizing paddles), a Turbulator® (high speed, horizontal screw) or a pneumatically fluidized bed.

The silane containing material may comprise any feasible organosilane, or mixtures of organosilanes. The silanes are of the structure XₐR_{b}R_{c}R_{d}Si, whereby X is a hydrolysable moiety chosen from halogens, preferable chloride, bromide or iodide and more preferable chloride, a hydrolysable moiety chosen from alkoxy, alcohol, esters and amines bearing hydrogen atom or bearing hydrocarbon radicals with homo atom or hetero atom chains ranging from about 1 to about 20, or from about 1 to about 8, or from about 1 to about 6, or from about 1 to about 4 including by not limited to methyl, methoxy, acetoxy, ethyl, ethoxy, propyl, propoxy, isopropyl, isopropoxy, butyl, iso-butyl, t-butyl, butoxy, iso-butoxy, t-butoxy and phenyl. The range for a can be from about 1 to about 3, and in some embodiments has a range of 3. R can be chosen from hydrocarbon radicals with homo atom or hetero atom chains ranging from about 1 to about 100, about 1 to about 30, about 1 to about 18, or about 1 to about 6 including alkyl, aryl, alkaryl, alkalkyl, alkylether, arylether, alkakylether, alkarylether, alkylester, arylester, alkalkylester, alkarylester, aklyamino, arylamino, alkalkylamino, alkarylamino, and more specifically include methyl, ethyl, propyl, iso-propyl, butyl, iso-butyl, t-butyl, pentyl and phenyl with the total of a+b+c+d equaling 4, preferable with b+c+d equaling 1.

Examples of silanes include Acetoxyethyldimethylchlorosilane, Acetoxyethylmethyldichlorosilane, Acetoxyethyltrichlorosilane, Acetoxymethyldimethylacetoxysilane, Acetoxymethyltriethoxysilane, Acetoxymethyltrimethoxysilane, Acetoxypropylmethyldichlorosilane, Acetoxypropyltrimethoxysilane, Benzyldimethylchlorosilane, Benzyltrichlorosilane, Benzyltriethoxysilane, Bis(methyldichlorosilyl)butane, Bis(methyldichlorosilyl)ethane, 1,2-Bis(trichlorosilyl)ethane. 1,8-Bis(trichlorosilyl)hexane. 1,9-Bis(trichlorosilyl)nonane, Bis(3-trimethoxysilyl)hexane, Bis[3-(trimethoxysilyl)propyl]ethylenediamine, 1,3-Bis(trimethylsiloxy)-1,3-dimethylsiloxane, n-Butyldimethylchlorosilane, n-Butyltrichlorosilane, t-Butyltrichlorosilane, 10-(Carbomethoxy)decyldimethylchlorosilane, 2-(Carbomethoxy)ethylmethyldichlorosilane, 2-(Carbomethoxy)ethyltrichlorosilane, 2-(Carbomethoxy)ethyltrichlorosilane, Carboxyethylsilanetriol Sodium Salt, 3-Chloropropylmethyldichlorosilane, 3-Chloropropylmethyldimethoxysilane, 3-Chloropropyltrichlorosilane, -Chloropropyltriethoxysilane, 3-Chloropropyltrimethoxysilane, 3-Cyanopropyldiisopropylchlorosilane, 3-Cyanopropyldimethylchorosilane, 3-Cyanopropyldimethylchlorosilane, 3-Cyanopropyltrichlorosilane, 3-Cyanopropyltriethoxysilane, 3-Cyanopropyltrimethoxysilane, n-Decyldimethylchorosilane, n-Decylmethyldichorosilane, n-Decyltrichorosilane, n-Decyltriethoxysilane, Di-n-Butyldichlorosilane, Diphenylmethylchlorosilane, Diphenylmethylethoxysilane, Diphenyldichlorosilane Diphenyldiethoxysilane, 1,7-Dichlorooctamethyltetrasiloxane, 1,5-Dichlorohexamethyltrisiloxane, 1,3-Dichlorotetramethyldisiloxane, (N,N-Dimethyl-3-aminopropyl)trimethoxysilane, Dimethyldichlorosilane, Dimethyldiethoxysilane, Dimethyldimethoxysilane, 3-(2,4-Dinitrophenylamino)propyl-triethoxysilane, Di-n-Octyidichlorosilane, Diphenyldichlorosilane, Diphenyldiethoxysilane, Diphenyldiethoxysilane, 2-(3,4-Epoxycyclohexylethyl)trimethoxysilane, Ethyldimethylchlorosilane, Ethylmethyldichlorosilane, Ethyltrichlorosilane, Ethyltriethoxysilane, Ethyltrimethoxysilane, (3-Gylcidoxypropyl)triethoxysilane, (3-Gylcidoxypropyl)trimethoxysilane, (Heptadecafluoro-1,1,2,2-Tetrahydrodecyl)dimethylchlorosilane, (Heptadecafluoro-1,1,2,2-Tetrahydrodecyl)trichlorosilane, (Heptadecafluoro-1,1,2,2-Tetrahydrodecyl)triethoxysilane, (Heptadecafluoro-1,1,2,2-Tetrahydrodecyl)methyldichlorosilane, (3 Heptafluoroisopropoxy)propyltrichlorosilane, n-Heptyidimethylchlorosilane, n-Heptylmethyldichlorosilane, n-Heptyltrichlorosilane, n-Hexadecyltrichlorosilane, n-Hexadecyltrimethoxysilane, Hexamethyldisilazane, Hexylmethyldichlorosilane, Hexyltrichlorosilane, Hexyltrimethoxysilane, 2-Hydroxy-4-(3-triethyoxysilylpropoxy)-diphenylketone, Isobutyldimethylchlorosilane, Isobutyltrichlorosilane, Isobutyltriethoxysilane, Isobutyltrimethoxysilane, 3-Isocyanatopropyltriethoxysilane, Isopropyldimethylchlorosilane, Isopropylmethyldichlorosilane, Mercaptomethylmethyldiethoxysilane, Mercaptopropylmethyldimethoxysilane, 3-Mercaptopropyltriethoxysilane, Mercaptopropyltriethoxysilane, Mercaptopropyltrimethoxysilane, 3-Mercaptopropyltrimethoxysilane, Methacryloxypropyltrichlorosilane, Methacryloxypropyltriethoxysilane, Methacryloxypropyltrimethoxysilane, 3-(p-Methoxyphenyl)propyltrichlorosilane, 3-Methoxypropyltrimethoxysilane, Methyltrichlorosilane, Methyltriethoxysilane, Methyltrimethoxysilane, n-Octadecyldiisobutyl(dimethylamino)si lane, n-Octadecyldimethylchlorosilane, n-Octadecyldimethyl(dimethlamino)silane, n-Octadecyldimethylmethoxysilane, n-Octadecyldimethyl(3-trimethoxysilylpropyl)ammonium chloride, n-Octadecylmethyldichlorosilane, n-Octadecylmethyldiethoxysilane, n-Octadecyltrichlorosilane, n-Octadecyltriethoxysilane, n-Octadecyltrimethoxysilane, n-Octyidiisobutylchlorosilane, n-Octyldiisopropylchlorosilane, n-Octyidiisopropyl(dimethlamino)silane, n-Octyidimethylchlorosilane, n-Octyidimethylmethoxysilane, n-Octyidimethyldimethylaminosilane, n-Octylmethyldichlorosilane, n-Octylmethyldiethoxysilane, n-Octyltrichlorosilane, n-Octyltriethoxysilane, n-Octyltrimethoxysilane, n-Octyldiisopropylchlorosilane, Pentafluorophenyldimethylchlorosilane, Pentafluorophenylpropyldimethylchlorosilane, Pentafluorophenylpropyltrichlorosilane, Pentafluorophenylpropyltrimethoxysilane, Pentyltrichlorosilane, Pentyltriethoxysilane, Phenethyldiisopropylchlorosilane, Phenethyldimethylchlorosilane, Phenethylmethyldichlorosilane, Phenethyldimethyl(dimethylamino)silane, Phenethyltrichlorosilane, Phenethyltrimethoxysilane, 3-Phenoxypropyldimethylchlorosilane, 3-Phenoxypropyltrichlorosilane, Phenyldimethylchlorosilane, Phenylmethyldichlorosilane, Phenylmethyldiethoxysilane, Phenylmethylmethoxysilane, Phenylpropyldimethylchlorosilane, Phenylpropylmethyldichlorosilane, Phenyltrichlorosilane, Phenyltriethoxysilane, Phenyltrimethoxysilane, n-Propydimethylchlorosilane, n-Propylmethyldichlorosilane, n-Propyltrichlorosilane, n-Propyltriethoxysilane, n-Propyltrimethoxysilane, Tetrachlorosilane, Tetraethoxysilane, 2,2,5,5-Tetramethyl-2,5-disila-1-aza-cyclopentane, Triacontyidimethylchlorosilane, Triacontyltrichlorosilane, (Tridecafluororo-1,1,2,2-tetrahydrooctyl)dimethylchlorosilane, (Tridecafluororo-1,1,2,2-tetrahydrooctyl)methyldichlorosilane, (Tridecafluororo-1,1,2,2-tetrahydrooctyl)trichlorosilane, (Tridecafluororo-1,1,2,2-tetrahydrooctyl)triethoxysilane, Triethyoxysilylpropylethylcarbamate, N-(3-Triethoxysilylpropyl)gluconamide, N-(3-Triethyoxysilylpropyl)-4-hydroxy-butyramide, N-(Triethoxysilylpropyl)-O-polyethylene oxide, 3-(Triethyoxysilylpropyl)succinic anhydride, Triethylacetoxysilane, Triethylchlorosilane, (3,3,3-Trifluoropropyl)dimethylchlorosilane, (3,3,3-Trifluoropropyl)methyldichlorosilane, (3,3,3-Trifluoropropyl)trichlorosilane, (3,3,3-Trifluoropropyl)trimethoxysilane, 2-(Trimethoxysilylethyl)pyridine, Trimethylchlorosilane, Trimethylethoxysilane, Trimethylmethoxysilane, Tri-n-propylchlorosilane, Undecyltrichlorosilane, Ureidopropyltriethoxysilane, Ureidopropyltrimethoxysilane, Vinylmethyldichlorosilane, Vinylmethyldiethoxysilane, Vinylmethyldimethoxysilane, Vinyltrichlorosilane, Vinyltriethoxysilane, Vinyltrimethoxysilane.

Silanes most useful for treating silica in this invention preferably have one or more moieties selected from the group consisting of alkoxy, quaternary ammonium, aryl, epoxy, amino, urea, methacrylate, imidazole, carboxy, carbonyl, isocyano, isothiorium, ether, phosphonate, sulfonate, urethane, ureido, sulfhydryl, carboxylate, amide, carbonyl, pyrrole, and ionic.

Examples for silanes having an alkoxy moiety are mono-, di-, or trialkoxysilanes, such as n-octadecyltriethoxysilane, n-octytriethoxysilane and phenyltriethoxysilane. Examples of silanes having a quaternary ammonium moiety are 3-(trimethoxysilyl)propyloctadecyldimethylammoniumchloride, N-trimethoxysilylpropyl-N,N,N-trimethylammoniumchloride, or 3-(N-styrylmethyl-2-aminoethylamino)-propyltrimethoxysilane hydrochloride. Examples of silanes having an aryl moiety are 3-(trimethoxysilyl)-2-(p,m-chlandomethyl)-phenylethane, 2-hydroxy-4-(3-triethoxysilylpropoxy)-diphenylketone, ((chloromethyl)phenylethyl)trimethoxysilane and phenyldimethylethoxysilane. Examples of silanes having an epoxy moiety are 3-glycidoxypropyltrimethoxysilane and 2-(3,4-epoxycyclohexyl)ethyltrimethoxysilane.

Examples of silanes having an amino moiety are 3-aminopropyltrimethoxysilane, N-(2-aminoethyl)-3-aminopropyltrimethoxysilane, trimethoxysilylpropyldiethylenetriamine, 2-(trimethoxysilylethyl)pyridine, N-(3-trimethoxysilylpropyl)pyrrole, trimethoxysilyipropyl polyethyleneimine, bis-(2-hydroxyethyl)-3-aminopropyltriethoxysilane, and bis(2-hydroxyethyl)-3-aminopropyltriethoxysilane.

Examples of silanes having a urea moiety are N-(triethoxysilylpropyl)urea and N-1-phenylethyl-N′-triethoxysilylpropylurea. An example of silanes having a methacrylate moiety is 3-(trimethoxysilyl)propyl methacrylate. An example of silanes having a sulfhydryl moiety is 3-mercaptopropyltriethoxysilane. Examples of silanes having an imidazole moiety are N-[3-(triethoxysilyl)propyl]imidazole and N-(3-triethoxysilylpropyl)-4,5-dihydroimidazole. Examples of ionic silanes are 3-(trimethoxysilyl)propyl-ethylenediamine triacetic acid trisodium salt; and 3-(trihydroxysilyl)propylmethylposphonate sodium salt. An examples of silanes having a carbonyl moiety is 3-(triethoxysilyl)propylsuccinic anhydride. Examples of silanes having an isocyano moiety are tris(3-trimethoxysilylpropyl)isocyanurate and 3-isocyanatopropyltriethoxysilane. Examples of silanes having an ether moiety are bis[(3-methyldimethoxysilyl)propyl]-polypropylene oxide and N-(triethoxysilylpropyl)-O-polyethylene oxide urethane. An example of a silane having a sulfonate moiety is 2-(4-chlorosulfonylphenyl)-ethyltrichlorosilane. An example of a silane having a isothiourium moiety is trimethoxysilylpropylisothiouronium chloride. Examples of silanes having an amide moiety are triethoxysilylpropylethyl-carbamate, N-(3-triethoxysilylpropyl)-gluconamide, and N-(triethoxysilylpropyl)-4-hydroxybutyramide. Examples of silanes having a urethane moiety are N-(triethoxysilylpropyl)-O-polyethylene oxide urethane and O-(propargyloxy)-N-(triethoxysilylpropyl)urethane.

Silica filter media can also be treated with more than one silanes such as N-trimethoxysilylpropyl-N,N,N-trimethylammonium chloride and bis(2-hydroxyethyl)-3-aminopropyltriethoxysilane; 3-aminopropyltrimethoxysilane and N-(triethoxysilylpropyl)-O-polyethylene oxide urethane; 3-trihydrosilylpropylmethylphosphonate, sodium salt and N-(triethoxysilylpropyl)-O-polyethylene oxide urethane; N-trimethoxysilylpropyl-N,N,N—Cl, trimethylammonium chloride and (3-glycidoxypropyl)trimethoxysilane; 3-trihydrosilylpropylmethylphosphonate, sodium salt and bis-(2-hydroxyethyl)-3-aminopropyltriethoxysilane; 3-(N-styrylmethyl-2-aminoethylamino)-propyltrimethoxysilane hydrochloride and N-(triethoxysilylpropyl)-O-polyethylene oxide urethane; 2-(trimethoxysilylethyl)pyridine and N-(3-triethoxysilylpropyl)-gluconamide; N-trimethoxysilylpropyl-N,N,N—Cl, trimethylammonium chloride and N-(3-triethoxysilylpropyl)-gluconamide; N-trimethoxysilylpropyl-N,N,N—Cl, trimethylammonium chloride and 2-hydroxy-4-(3-triethoxysilylpropoxy)-diphenylketone; 3-mercaptopropyltriethoxysilane and N-(triethoxysilylpropyl)-O-polyethylene oxide urethane; 3-(triethoxysilyl)propylsuccinic anhydride and N-(triethoxysilylpropyl)-O-polyethylene oxide urethane; trimethoxysilylpropyl-ethylenediamine, triacetic acid, trisodium salt and N-(triethoxysilylpropyl)-O-polyethylene oxide urethane; 2-(4-chlorosulfonylphenyl)-ethyltrichlorosilane and N-(triethoxysilylpropyl)-O-polyethylene oxide urethane; and 2-(4-chlorosulfonylphenyl)-ethyltrichlorosilane and bis-(2-hydroxyethyl)-3-aminopropyltriethoxysilane.

The silane containing material may be provided by any effective feeding mechanism known to one skilled in the art. In one embodiment, the silane containing material is sprayed onto the fluidized particulates with an aerosol sprayer, for example as a mist or airborne droplets. In one embodiment, the silane droplets may have a droplet size substantially the same as that of an individual particulate. This enables rapid and intimate contact and reaction between the two materials. The liquid droplets and the fluidized particulates contact each other and the liquid coats and reacts with the surfaces of the particles. Typically, the fluidized particulates and silane droplets homogeneously attach to one another. In one embodiment, a ligand of the silane may bind to a particulate receptor to form a silane-functionalized particulate. Additionally, by utilizing fluidized particulates, there is an immediate contact of liquid droplet to particulate instead of delays encountered in conventional batch mixing processes prior to achieving a homogeneous mixture and coating. The silane containing material may contact with the fluidized particulates for any duration desired by the user. In one embodiment, the silane may contact with the particulates for up to a day, or about 6 hours, or about 3 hours, or about 1 hour, or about 30 minutes. These temperatures can range from 25° C. to 150° C., preferably 80° C. to 110° C. Typically, a mass of liquid equal to the powder load can be sprayed into the reactor, preferably 30% liquid (of entire loading), or 20% or 10% and more preferably 5% or 1%.

In a further embodiment of the method, the silane containing material may optionally include a solvent, such as ethanol; however, the amount of solvent is minimized to an amount effective to prevent clogging in a spray mechanism. Solvents suitable for this include ethanol, methanol, butanol, pentanol, hexanol, heptanol, octanol, nonanol, decanol and other higher boiling alkyl alcohols, toluene, xylene, and other aromatic solvents, glyme, diglyme, ethyl ether, pentane, hexane, heptane, octane, nonane, decane and other higher boiling hydrocarbon solvents, tetrahydrofuran, furan, or other solvents known to one skilled in the art. Unlike the prior art wet process, the use of a solvent is not required to accelerate the reaction of silane with the surface of the particulate, thus in accordance with one embodiment, zero solvent is included in the total processed load. In accordance with one embodiment, the solvent may comprise up to about 50%, or up to about 10%, or up to about 5% of a total processed load for the purpose of aerosol formation, wherein the total processed load comprises the silane-containing material, the fluidized particulates, and the solvent. The solvent may comprise a mixture of the above-described solvents. Generally, the solvent is inert with respect to the silane-containing material.

The method is advantageous, because the reaction of the particulates with the silane containing material may occur without the addition of solvents, rubbers, or other additional materials. Previous dry processes compounded particles with the use of a rubber or viscous polymer. In embodiments of the present invention, the silane-containing material directly contacts and reacts with the surfaces of the particulates, without using rubber, to form silane-functionalized particulates characterized by the chemical attachment of the silane to the surface of the particulates. Additionally, fluidizing the particles effectively facilitates the reaction of the particulates and the silane, thus rendering unnecessary the addition of any catalyst.

In further embodiments, the method may also comprise heating the reacting fluidized particulates and silane containing material to a temperature effective to volatilize and/or remove alcohol, solvents, and/or reaction by-products. The method may also selectively evaporate any solvent through a process vent. Because the amount of solvent used in the reaction is minimized, additional processing steps directed to removing solvent may also be minimized. The heating may also accelerate the attachment reaction of the silane to the particulate. These temperatures can range from about 25° C. to about 150° C., or in one exemplary embodiment, from about 80° C. to about 110° C.

Referring to FIG. 1, a system 1 for functionalizing particulates is provided in accordance with the present invention. The system 1 comprises a reactor, such as a plow blade mixer 10, operable to create and maintain a fluidized bed of particulates (not shown), a source 20 of a silane containing material 40, and a spraying mechanism 30 operable to spray the silane containing material 30 onto the fluidized bed of particulates. The system 1 may also comprise a feed port 5 for providing particulates to the plow blade mixer 10. The plow blade mixer 10 may also comprise an agitator 15 to fluidize, typically by circulating, the particulates and silane inside the mixer. The plow blade mixer 10 may also comprise an outlet 50 to deliver the silane-functionalized particulate product out of the mixer, a heater (not shown) to heat the reacting particulates and silane, and a process vent (not shown) to remove any remaining volatile solvents or by-products. Moreover, the system may also comprise a source of a flushing agent, such as a solvent material, operable to flush the silane-containing material from the spraying mechanism 30.

The following examples illustrate a few methods of producing silane-functionalized particulates in accordance with embodiments of the present invention. The examples are meant to be illustrative and should not be construed as limiting the invention to the particular methods and devices, which are used.

### EXAMPLE 1

1. Load 7 lbs of RiceSil 1001 (rice hull ash) RHA to Littleford Day® M-20 Plow blade mixer.

2. Turn agitator on to full speed (220 RPM) and heat to 158° F.

3. Add 138 grams of Dow Corning® Z-6020 Silane to the RHA in the mixer through the two-fluid spray nozzle from a nitrogen-pressurized vessel. Fluidizing gas is nitrogen.

4. Flush the silane feed system into the batch with 200 grams of ethanol.

5. Hold batch at 160° F. for 20 minutes to complete reaction and drive off alcohol.

6. Turn off agitator and discharge treated RHA to container.

### EXAMPLE 2

1. Load 6 lbs of RiceSil 100® RHA to Littleford Day® M-20 Plow blade mixer.

2. Turn agitator on to full speed (220 RPM) and heat to 157° F.

3. Add 508 grams of Dow Corning® 5700 Silane to the RHA in the mixer through the two-fluid spray nozzle from a nitrogen-pressurized vessel. Fluidizing gas is nitrogen.

4. Flush the silane feed system into the batch with 200 grams of ethanol.

5. Hold batch at 160° F. for 10 minutes to complete reaction and drive off alcohol.

6. Turn off agitator and discharge treated RHA to container.

### EXAMPLE 3

1. Load 6 lbs of RiceSil 100® RHA to Littleford Day® M-20 Plow blade mixer.

2. Turn agitator on to full speed (220 RPM) and heat to 157° F.

3. Add 504 grams of Dow Corning® Z-6032 Silane to the RHA in the mixer through the two-fluid spray nozzle from a nitrogen-pressurized vessel. Fluidizing gas is nitrogen.

4. Flush the silane feed system into the batch with 200 grams of ethanol.

5. Hold batch at 160° F. for 10 minutes to complete reaction and drive off alcohol.

6. Turn off agitator and discharge treated RHA to container.

The above examples produce silane-functionalized particulates, wherein the silane and particulates are chemically attached. The chemical attachment prevents the silane additive from being removed from the silane-functionalized particulates during solvent washings. Moreover, as illustrated in FIG. 2, infrared spectroscopy data shows that free silanol content on the surface of the RHA decreases after treatment, thus demonstrating that chemical attachment has occurred.

It is noted that terms like “specifically,” “preferably,” “commonly,” and “typically” and the like, are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A method of functionalizing particulates comprising:
providing particulates to a reactor;
fluidizing particulates in substantial absence of solvents;
providing a silane containing material to the fluidized particulates; and
reacting the silane containing material with the fluidized particulates to provide silane functionalized particulates.

2. A method according to claim 1 further comprising heating the reacting fluidized particulates and silane containing material to temperature effective to volatilize and/or remove alcohol, solvents, and/or other by-products.

3. A method according to claim 2 further comprising selectively evaporating any solvent through a process vent.

4. A method according to claim 1 wherein the silane containing material and the fluidized particulates react by attaching a ligand of the silane containing material with a particulate receptor.

5. A method according to claim 1 wherein the particulates comprise a particle size of up to about 500 μm.

6. A method according to claim 1 wherein the particulates comprise amorphous silica, inorganic materials, or combinations thereof.

7. A method according to claim 6 wherein the amorphous silica is of biogenic origin.

8. A method according to claim 7 wherein the amorphous silica comprises rice hull ash, oat bran ash, wheat chaff ash, or combinations thereof.

9. A method according to claim 6 wherein the inorganic materials comprises diatomaceous earths, high-pressure liquid chromatography (HPLC) grade silica, titania, zirconia, and combinations thereof.

10. A method according to claim 1 wherein the silane containing material comprises alkoxysilane.

11. A method according to claim 1 wherein the silane containing material is sprayed onto the fluidized particulates as an aerosol.

12. A method according to claim 1 wherein the silane containing material comprises droplets having a droplet size substantially the same as that of an individual particulate.

13. A method according to claim 1 wherein the silane containing material comprises an amount of solvent, which is inert with respect to the silane-containing material.

14. A method according to claim 13 wherein the solvent comprises up to about 5% of a total processed load, wherein the total processed load comprises the silane-containing material, the fluidized particulates, and the solvent.

15. A method according to claim 1 wherein the silane containing material reacts with the fluidized particulates for up to about 3 hours.

16. A system for functionalizing particulates comprising:
a reactor operable to create and maintain a fluidized bed of particulates;
a source of a silane containing material; and
a spraying mechanism operable to spray the silane containing material onto the fluidized bed of particulates.

17. A system defined by claim 16 wherein the reactor comprises a plow blade mixer.

18. A system defined by claim 16 further comprising a source of a flushing agent operable to flush the silane-containing material from the spraying mechanism.

19. A system defined by claim 16 further comprising a heater operable to heat a mixture comprising particulates and silane to a temperature effective to remove alcohol by-products, solvents, or combinations thereof and is further operable to accelerate the reaction of the silane and the particulates.

20. A system defined by claim 16 further comprising a process vent operable to divert from the reactor any evaporating solvent or by-product.

21. A system defined by claim 16 further comprising an inlet port operable to provide particulates to the reactor, and an outlet port operable to deliver a product comprising silane-functionalized particulates out of the reactor.

22. A system defined by claim 16 further comprising an agitator operable to fluidize the particulates in the reactor by stirring.
